(19) United States
(12) Patent Application Publication
(10) Pub. No.: US 2011/0093411 A1
(43) Pub. Date: Apr. 21, 2011

(54) Method and apparatus to reduce risk of identity theft

(76) Inventor: James D. Gibson, Phoenix, AZ (US)

(21) Appl. No.: 12/589,189

(22) Filed: Oct. 20, 2009

(51) Int. Cl. G06Q 90/00

(52) U.S. Cl. 705/500

(57) ABSTRACT

A method to reduce the risk of identity theft prevents the gathering and correlation of personal information on an individual's private real property. The method selectively obscures identification indicia on personal property when the personal property is located on private real property.

This invention relates to a method and apparatus for reducing the risk of identity theft.

Since identity theft has become more prevalent in the United States, consumers are more cognizant about protecting personal information when their personal property is utilized in public places. For example, many articles and advisories have been produced about protecting credit card information when a credit card is publicly used to used to purchase merchandise. Insuring that a credit card number is not reflected on a store receipt is one common recommendation in this respect, as is the suggestion that a customer not give a credit card to a waiter or other personnel in a restaurant or store who will carry the card to a location that is out-of-site from the customer. Another similar example is to restrict public dissemination of one's social security number. While the protection of personal information in public places is a common goal, in many cases consumers assume that once that they return home to their private residence their personal information is protected unless an overt action is taken to break into their home. This simply is not always the case.

Accordingly, it would be highly desirable to provide an improved method and apparatus for reducing the risk of identity theft.

Therefore, it is a principal object of the invention to provide an improved method and apparatus to reduce the likelihood that personal information about a consumer can be gathered from the consumer's home site and correlated to facilitate identity theft.

These and other, further and more specific objects and advantages of the invention will be apparent from the following detailed description of the invention, taken in conjunction with the drawings, in which:

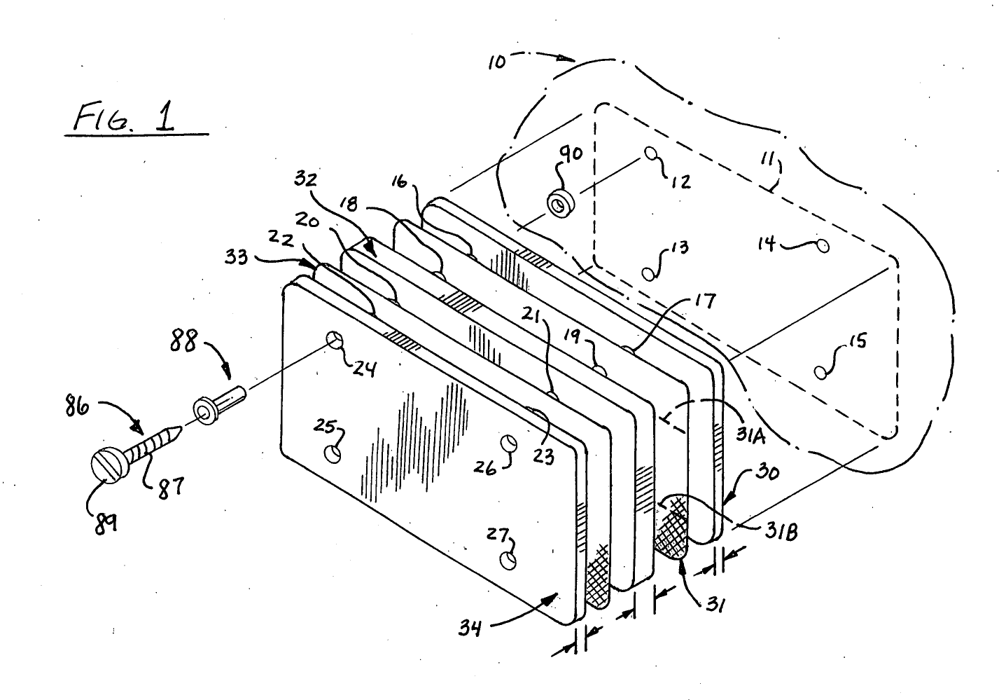

FIG. 1 is an exploded perspective view illustrating apparatus utilized in accordance with a perspective view illustrating apparatus constructed in accordance with one method of the invention;

FIG. 2 is a front view further illustrating the apparatus of FIG. 1 assembled;

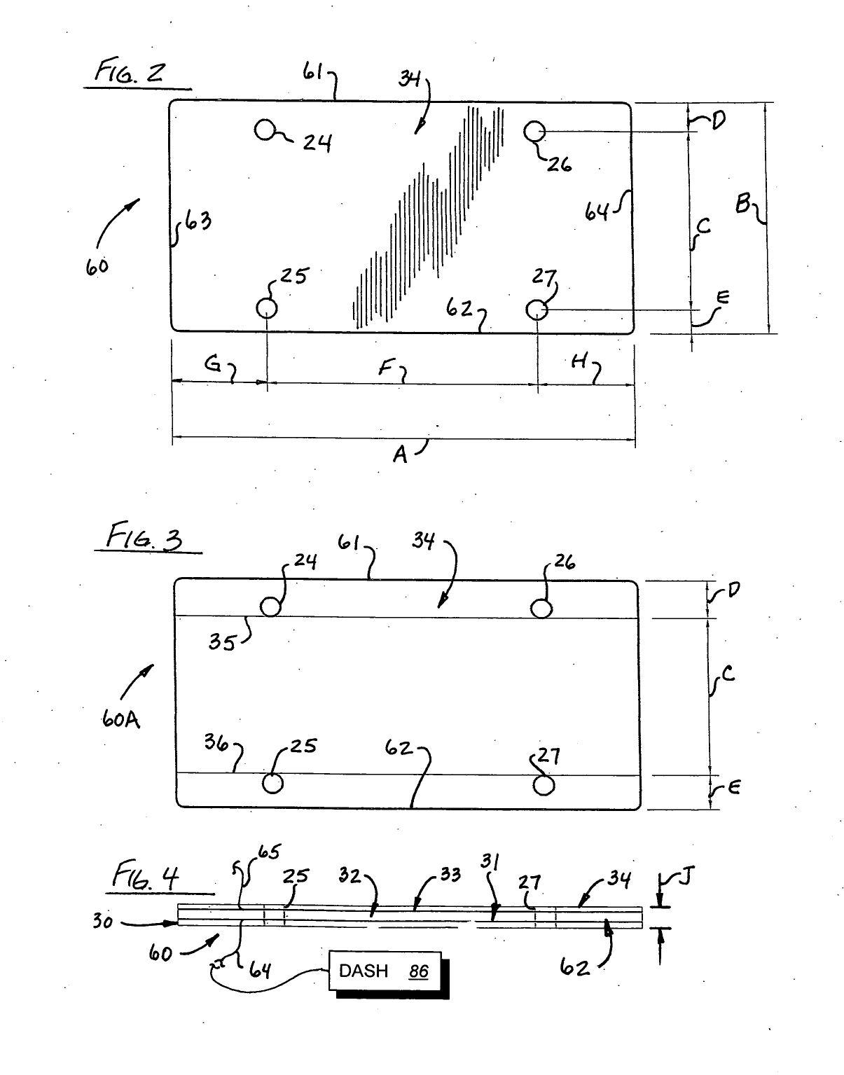

FIG. 3 is a front view illustrating an alternate embodiment of the apparatus of FIG. 1 assembled;

FIG. 4 is a bottom view further illustrating the apparatus of FIG. 1 assembled;

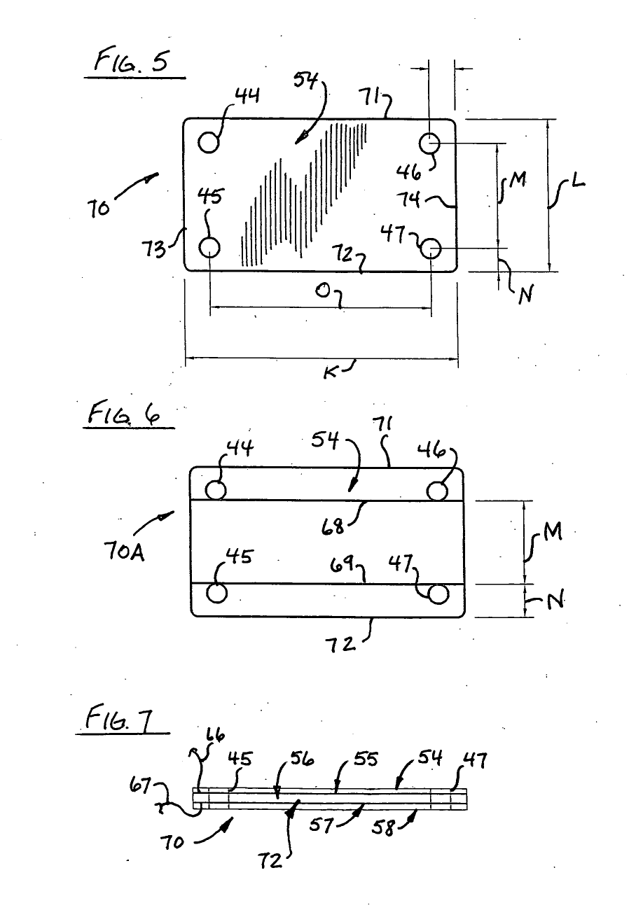

FIG. 5 is a front view illustrating an alternate apparatus constructed in accordance with the invention;

FIG. 6 is a front view illustrating an alternate configuration of the apparatus of FIG. 5;

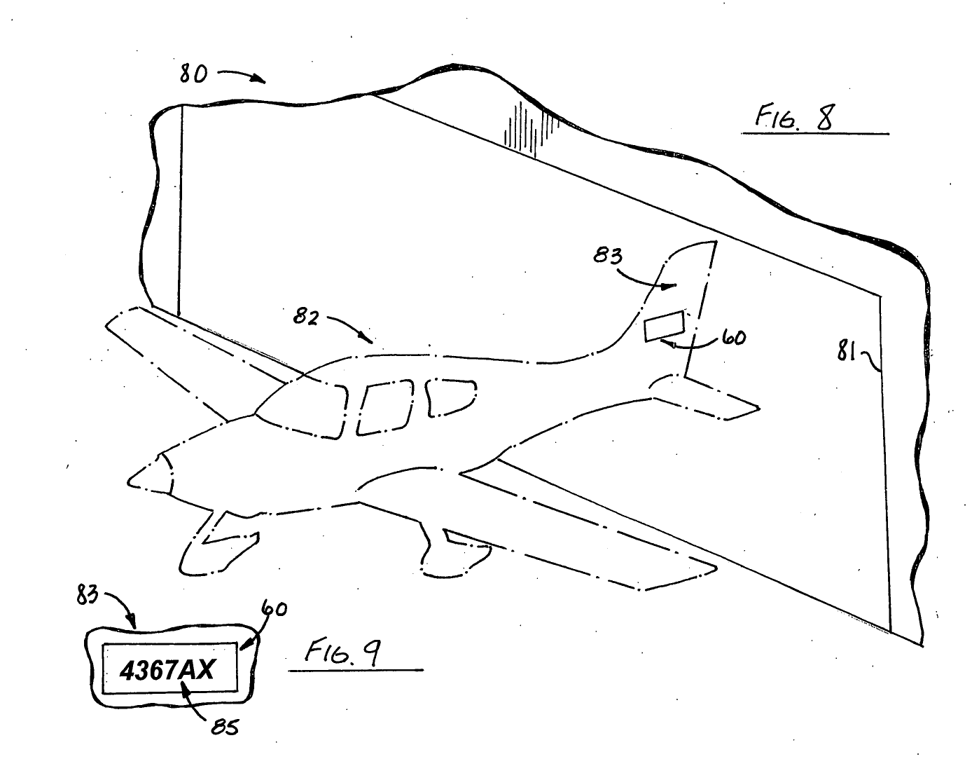

FIG. 7 is a bottom view further illustrating the apparatus of FIG. 5;

FIG. 8 is a perspective view illustrating the mode of operation of the invention; and,

FIG. 9 is a front view illustrating mounting of apparatus utilized in the practice of the invention.

Briefly, in accordance with my invention, I provide an improved method to reduce the risk of identity theft by preventing the gathering and correlation of personal information at an individual's private real property. The method includes the steps of identifying an item of personal property including visible identification indicia; providing a building structure at the individual's real property for storing the item of personal property; mounting on the personal property elongate panel apparatus covering the indicia, the apparatus operable to change the apparatus from a first operative opaque configuration preventing viewing of the indicia to a second operative transparent configuration permitting viewing of the indicia, and vice-versa; providing a storage building at the individual's residence for the item of personal property; storing the item of personal property in the storage building on the individual's real property with the panel apparatus in the first operative opaque configuration; removing the item of personal property from the individual's real property with the panel apparatus in the first operative opaque configuration; traveling a first selected distance from the real property; after traveling the selected distance from the real property, operating the panel apparatus to change from the first operative configuration to the second operative configuration; traveling a second selected distance; after traveling a second selected distance operating the panel apparatus to change from the second operative configuration to the first operative configuration; returning the item of personal property to the storage building with said panel apparatus in the second operative configuration; and, storing the personal property in the storage building in the second operative configuration.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1, 2 and 4 illustrate apparatus utilized in one embodiment of the invention and including substantially rigid transparent glass panels 30, 32, 34 and panels or film or mesh 31 and 33 that are comprised of electronic smart glass, electrochromatic glass or some other material that is opaque but experiences a decrease in opacity (or vice-versa) when electricity is applied to the panel 31, 33. One example of such a film is PDLC film (Polymer Dispersed Liquid Crystal film) sold by Sager Technology Co., Ltd. This film is a light modulating material comprised of droplets of liquid crystal uniformly dispersed in a flexible plastic film. When power is off, incoming visible light scatters through the PDLC, and the film is translucent. When the power is on, the film is clear and incoming visible light transmits through the PDLC.

The panels 30 to 33 can be secured together with an adhesive or any other desired fastening system, but presently are sealingly permanently pressed together under high pressure with an adhesive or other sealing agent between each pair of adjacent panels. The overall thickness J (FIG. 4) of assembled unit 60 is preferably at least three-eighths of an inch, more preferably at least one-half inch, and most preferably at least three-quarters of an inch. This thickness is necessary to insure that indicia on the personal property on which unit 60 is mounted can not be read when the unit 60 is adjacent and contacting the personal property or is quite close—typically about one-sixteenth to three-sixteenths of an inch or less—to the portion of the outer surface of the personal property on which the indicia are located. The thickness of glass panel 30 is preferably at least two mm (millimeters), more preferably at least three mm. The thickness of glass panel 32 is preferably at least three mm, more preferably at least four mm, and most preferably at least six mm. The thickness of glass panel 34 is at least two mm, preferably at least three mm. Panels 30, 32, 34 are preferably fabricated from glass, but can be produced using a transparent polymer or other transparent material. When glass is utilized in the compression sealing manufacturing process used to produce a unit 60, each panel 30, 32, 34 must be at least three mm thick. As used herein, if a material permits a person to see through the material—as is the case with the front windshield of an automobile (tinted or not)—the material is transparent. Mounting unit 60 in close proximity to the outer surface of the personal property is important in the practice of the invention because it minimizes or completely prevents the flow of air or other fluids intermediate unit 60 and the personal property, because it creates a better aerodynamic profile which can be important in the use of the personal property, and because it makes unit 60 less detectable once it is mounted.

As illustrated in FIG. 2, unit 60 includes upper edge 61, lower edge 62, side edge 63, side edge 64, and apertures 24 to 27 formed through panel 31. Although the shape and dimension of unit 60 can vary as desired, unit 60 is presently substantially rectangular and has a length A and a height B. The distance between the center points of apertures 25 and 27 is indicated by arrows F. The distance between the center points of apertures 24 and 26 is equal to the distance between the center points of apertures 25 and 27. The distance between the center points of apertures 26 and 27 is indicated by arrows C. The distance between the center points of apertures 24 and 25 is equal to the distance between the center points of apertures 26 and 27. The distance of the center point of aperture 26 from top edge 61 is indicated by arrows D. The distance of the center point of aperture 27 from bottom edge 62 is indicated by arrows E. The distance of the center point of aperture 24 from upper edge 61 equals the distance of the center point of aperture 25 from bottom edge 62 which equals the distance indicated by arrows E. The distance from the center of each aperture 26 and 27 to side 64 is indicated by arrows H. The distance from the center of each aperture 24 and 25 to side 63 is indicated by arrows G. The distance indicated by arrows H is equivalent to the distance indicated by arrows G. The diameter of each aperture 24 to 27 is equivalent to the other apertures 24 to 27 and is equivalent to apertures 22, 23 formed in panel 33; to apertures 20, 21 formed in panel 32; to apertures 18, 19 formed in panel 31; and, to apertures 16, 17 formed in panel 30. Four apertures with spacing and size equivalent to that of apertures 24 to 27 are formed in each panel 30 to 33, although only two of such apertures in each panel 30 to 33 are partially visible in FIG. 1. The diameter of each such aperture 16 to 27 visible in FIG. 1 normally is greater than the diameter of the threaded portion 87 of a screw that is turned into and through an aperture 12 to 15 in a license plate 11 or other portion of an item of personal property to affix unit 60 to the item of personal property. The larger size of apertures 16 to 27 with respect to threaded portion 87 provides “play” (even if bushings 88 are utilized) when unit 60 is being installed in registration with a license plate 11 having a length and height comparable to that of unit 60. Although the screw 86 illustrated in FIG. 1 is installed utilizing a flat blade screw driver, the screws 86 or other fasteners utilized to secure unit 60 to a portion of a piece of personal property preferably require the use of an Allen wrench or other specialized tool, this to discourage theft of a unit 60 from its installed location on a piece of personal property.

In one embodiment of the invention, a registration number (not shown) is etched or otherwise formed on a portion of a unit 60, preferably on the inside of a panel 30 or 31. This permits ready identification of a unit 60 in the event it is stolen. An electronic chip or other device can be attached to or embedded in a unit 60 which enables the location of a unit 60 to be located utilizing a satellite or other desired sensing equipment.

In another embodiment of the invention, panel 34 has a width of three mm, panel 33 has a width of 0.5 mm, panel 32 has a width of 4.0 mm, panel 31 has a width of 0.5 mm, panel 30 has a width of 6 mm, and a spacer panel or spacers having a width of 2 mm is inserted between panel 30 and the surface of the item of personal property on which a unit 60 is mounted. In this case, the unit 60 has a total width J (FIG. 4) equal to 14 mm, and the spacer(s) position unit 60 two mm away from the surface of the item of personal property on which a unit 60 is mounted. In order to attain the required degree of opacity to prevent indicia on the outer surface of a selected piece of personal property from being viewed, It is critical in the practice of the invention that—after a unit 60 is mounted on the outer surface—a first electrochromatic panel 31 is spaced apart from the outer surface of the piece of personal property and that a second electrochromatic panel 33 is spaced apart from the first electrochromatic panel. It is also critical that the unit 60 be mounted in a vertical orientation on the outer surface of the selected piece of personal property. Panels or film 31 and 33 have a width less than two mm, preferably less than one mm, and most preferably less than 0.75 mm.

The height B and length A of each panel 30 to 34 in unit 60 are equivalent to the height and width of a license plate or to the desired area of another portion of personal property covered by unit 60, although this need not be the case. For example, the unit 60A illustrated in FIG. 3 is identical to unit 60 except that panels 30 and 31 are each replaced with an electrochromatic panel that has a length equal to arrow A, but has a reduced width equal to the distance between lines 35 and 36 in FIGS. 1 and 3. As indicated in FIG. 1, such a reduced size electrochromatic panel would only extend between dashed lines 31A and 31B. This means that the portions of unit 60A extending between line 35 and top edge 61 and extending between line 36 and bottom edge 62 are continually transparent because electrochromatic panels are not sandwiched in these portions of unit 60A. Such transparency is important because it makes it more difficult for unit 60A to be utilized in a manner that interferes with law enforcement officers. This is because license plate tags that may be placed near the upper edge or lower edge of a license plate will always be visible through the continually transparent and lower portions of unit 60B.

In FIG. 4, each electrochromatic panel 31, 33 includes a pair of leads that extend from unit 60 to a desired location on the personal property on which unit 60 is mounted. The electrical conduit identified by reference character 64 comprises a pair of electrical leads, one of which delivers electricity into panel 31 and the other of which carries electricity away from panel 31. Conduit 64 leads to a dash 86 unit comprising a switch, electrical transformer, and/or battery or other electrical power source. In one embodiment, conduit 64 is connected to a connector which plugs into a cigarette lighter socket in the dashboard of a vehicle. When the connector is plugged into the cigarette light socket, electrical power is delivered to panel 31 and panel changes from an opaque to a transparent state. Or, if desired, conduit 64 can be permanently plugged into a cigarette light socket and a switch installed in conduit 64 to control whether panel 31 is in the opaque (switch off) or transparent (switch on) configuration. The conduit 65 leading from panel 33 is connected in a manner similar to that just described for conduit 64.

In one preferred embodiment of the invention, in unit 60 the distances E and D each equal 11/16 of an inch, the distance C equals 4 11/16 of an inch, the distance F equals seven inches, and the distances G and H each equal two and one-half inches.

As illustrated in FIG. 5, unit 70 (which is smaller than unit 60) includes upper edge 71, lower edge 72, side edge 73, side edge 74, and apertures 44 to 47 formed through panel 54. Although the shape and dimension of unit 60 can vary as desired, unit 60 is presently rectangular and has a length K and a height L. The distance between the center points of apertures 45 and 47 is indicated by arrows O. The distance between the center points of apertures 44 and 46 is equal to the distance between the center points of apertures 45 and 47. The distance between the center points of apertures 46 and 47 is indicated by arrows M. The distance between the center points of apertures 44 and 55 is equal to the distance between the center points of apertures 46 and 47. The distance of the center point of aperture 46 from top edge 71 is equal to the distance of the center point of aperture 47 from the bottom edge 72 which is indicated by arrows N. The distance of the center point of aperture 44 from upper edge 71 equals the distance of the center point of aperture 45 from bottom edge 72 which equals the distance indicated by arrows E. The construction of unit 70 is essentially equivalent to that of unit 60, except unit 70 consists of smaller panels 54 to 58.

The height L and length K of each panel 54 to 58 in unit 70 (FIG. 7) are equivalent to the length and width of a license plate or to the desired area of another portion of personal property covered by unit 70, although this need not be the case. For example, the unit 70A illustrated in FIG. 6 is identical to unit 70 except that panels 55 and 57 are each replaced with an electrochromatic panel that has a length equal to arrow K, but has a reduced width equal to the distance between lines 68 and 69 in FIG. 6. This means that the portions of unit 70A extending between line 68 and top edge 71 and extending between line 69 and bottom edge 72 are continually transparent. Such transparency is important because it makes it more difficult for unit 70A to be utilized in a manner that interferes with law enforcement officers. This is because license plate tags that may be placed near the upper edge or lower edge of a license plate will always be visible through the continually transparent and lower portions of unit 70B. In FIG. 7, each electrochromatic panel 55, 57 includes a pair of leads (not shown) that extend from unit 70 to a desired location on the personal property on which unit 70 is mounted. These electrical leads operate in a manner similar to that described for leads 64 and 65. When a unit 60, 60A, 70, 70A is utilized on a vehicle, the electrical leads preferably extend inside the vehicle—for example to the driver compartment or cockpit—to a switch that is near the vehicle operator when he is seated in the vehicle and that permits the vehicle operator to conveniently operate the unit 60 to produce an opaque configuration of the electrochromatic panels in the unit 60 or to produce a transparent configuration of the electrochromatic panels in the unit 60.

### EXAMPLE

This example is provided by way of explanation, and not limitation, of the invention.

A piece of personal property is selected. The personal property comprises an airplane 82 having a tail section 83 with an identification number “4367AX” 85 imprinted or otherwise formed on the outer surface of the tail section 83 of the fuselage. The plane 82 is stored in a hangar or other building structure 80 on a piece of property. The plane 82 is owned by an individual or is owned by others who do not consider the plane to be public property. Similarly, the hangar and land on which the hangar is built can be owned by the individual or can be owned by others who do not consider the hangar to be public property. For example, a flying club can own the plane, building, and real estate on which the hangar is built. The club does not consider the plane, building and real estate to be public property. In general, the only individuals allowed on the property and in the plane are authorized members of the flying club. Consequently, the plane, building, and land are private property. The club may lease the plane and building. Still, the club does not consider the plane, building and real estate to be public property. Only authorized members of a club are permitted to use the facilities. Similarly, the homes which members of the club own or lease are private property. Likewise, a boat stored at a location at which public access is not permitted is considered to be stored on private property.

The ability of a criminal to carry out identity theft is simplified when the criminal can correlate two or more valuable pieces of information. One example of a valuable piece of information is the license or identification number or registration number on a piece of personal property like an airplane, boat, car, etc. A second example of a valuable piece of information is the home address of the individual that possesses, owns, or is using the personal piece of property. It is common for an individual not to think twice about parking his plane or boat at a particular address. Unfortunately, it is possible for a criminal to note the identification number on the piece of personal property, to note the address at which the personal property is kept, to note the manufacturer and (in the case of airplanes or other vehicles) the particular make of the vehicle, and, in many cases to get the name of the owner or user off the mailbox, the personal property, or a building at the particular street address. That comprises a substantial amount of information. Accordingly, in a substantial number of cases “there is no place like home” when it comes to a criminal gathering information about your activities and your ownership of various kinds of personal property.

In FIG. 8, a unit 60 is mounted in a vertical orientation on the exterior surface of the fuselage of plane 82 over the identification number “4367AZ” on the tail of the plane. As noted, the panels comprising unit 60 are sealed together such that air or water can not flow or penetrate between panels 30 to 34. Unit 60 can be constructed with a tapered peripheral edge to facilitate the flow of air over unit 60. If spacers 90 are utilized between panel 30 and the exterior surface of the plane, they have a thickness of no more than one-eighth of an inch. Spacers 90 are preferably not utilized. Unit 60 includes a control switch in the cockpit. When the switch is in the “off” position, electricity does not flow to electrochromatic panels 31 and 33 and the panels 31 and 33 are sufficiently opaque to cover and prevent an individual standing by the plane from seeing and reading the identification number. When the switch is in the “on” position, electricity flows through panels 31 and 33 and the panels 31 and 33 become transparent and permit an individual standing along side plane to see and read the identification number “4367AX” through the panels comprising unit 60.

When plane 82 is parked in hangar 80 (or outside), the control switch is normally in the “off” position, unit 60 is opaque, and an individual standing next to plane 82 can not read the identification number “4367AX.” When a pilot takes plane 82 on a flight, he taxies out of the hanger with the unit 60 control switch in the “off” position. This prevents an observer who is adept at identity theft from viewing the identification number of the plane. After the plane takes off and has taxied or flown a selected distance from hangar 80, the pilot turns the unit 60 control switch to the “on” position so that other pilots can, if necessary, view the identification number. When the pilot returns from his flight, and is a selected distance from hangar 80, he turns the control switch to the “off” position to obscure the identification number while he travels to the hangar and parks. If at any time authorized personnel need to see the identification number while plane 82 is on the ground, it is a simple matter for a pilot to turn the unit 60 control switch to the “on” position.

One proposed MO (method of operation) to carry out a terror attack comprises utilizing a plane to disperse toxic chemicals or pathogens. Terrorists often gain a feeling of additional success when they can use stolen American property to help kill Americans. Using the MO of identity theft to gain possession and use of private property is one approach that is perfectly acceptable to a terrorist. The methodology of the invention facilitates denying ready access to useful identification information about an aircraft.

Importantly, when, in use of the invention, personal property is being stored at or transported to and from private property, a unit 60 can prevent an unauthorized person from viewing an identification number, license number, registration number, or any other information on the personal property. Installation and use of a unit 60, 70, 60A, 70A is a straightforward and provides a simple strategy for making it more difficult for a person to gain access to an individual's personal information.

Having described my invention in such terms as to enable those of skill in the art to make and practice it, and having described the presently preferred embodiments thereof, I claim:

1. A method to reduce the risk of identity theft by preventing the gathering and correlation of personal information on an individual's private real property, comprising the steps of
(a) identifying an item of personal property including visible identification indicia;
(b) providing a building structure at the individual's real property for storage said item of personal property;
(c) mounting elongate panel apparatus covering said indicia, said apparatus operable to change said apparatus from a first operative opaque configuration preventing viewing of said indicia to a second operative transparent configuration permitting viewing of said indicia, and vice-versa;
(d) providing a storage building at the individual's residence for said item of personal property;
(e) storing said item of personal property in said storage building on the individual's real property with said panel apparatus in said first operative opaque configuration;
(f) removing said item of personal property from the individual's real property with said panel apparatus in said first operative opaque configuration;
(g) traveling a first selected distance from said real property; and,
(h) after traveling said selected distance from said real property, operating said panel apparatus to change from said first operative configuration to said second operative configuration;
(i) traveling a second selected distance;
(j) after traveling a second selected distance operating said panel apparatus to change from said second operative configuration to said first operative configuration;
(k) returning said item of personal property to said storage building; and
(i) storing said personal property in said storage building in said second operative configuration.
